(19) United States
(12) Patent Application Publication
(10) Pub. No.: US 2006/0102131 A1
(43) Pub. Date: May 18, 2006

(54) Piston apparatus with oil scraper ring

(75) Inventor: Geum Tai Han, Yuseong-gu (KR)

Correspondence Address: Richard P. Berg, Esq.;c/o LADAS & PARRY, Suite 2100, 5670 Wilshire Boulevard, Los Angeles, CA, 90036-5679, US

(73) Assignee: SAMYOUNG MACHINERY CO., LTD.

(21) Appl. No.: 11/148,792

(22) Filed: Jun. 8, 2005

(30) Foreign Application Priority Data
Nov. 17, 2004 (KR) 10-2004-0094164

(51) Int. Cl. F02F 3/08; F02F 5/00

(52) U.S. Cl. 123/193.4; 277/460

(57) ABSTRACT

The present invention provides a piston apparatus having an oil scraper ring, by which smoke due to incomplete combustion of fuel is prevented in a manner of preventing oil attached to an inner cylinder wall and piston in an internal combustion engine from rising into a combustion room by a reverse pressure and preventing a blow-by phenomenon and in which the oil scraper ring can play roles as an oil ring and an oil scraper to prevent excessive oil consumption. The present invention includes an oil scraper ring provided to a ring groove formed below the compression ring, wherein upper and lower protrusions provided to an outer circumference of the oil scraper ring to be brought into contact with an inner circumference of a cylinder and wherein the upper and lower protrusions built in one body have no perforated hole in-between to provide a scraper function and an oil ring function simultaneously.

This application claims the benefit of the Korean Application No. P2004-94164 filed on Nov. 17, 2004, which is hereby incorporated by reference.

### BACKGROUND OF THE INVENTION

1. Field of the Invention

The present invention relates to a piston of a diesel internal combustion engine, and more particularly, to a piston apparatus having an oil scraper ring, by which smoke due to incomplete combustion of fuel is prevented in a manner of preventing oil attached to an inner cylinder wall and piston in an internal combustion engine from rising into a combustion room by a reverse pressure and preventing a blow-by phenomenon and in which the oil scraper ring can play roles as an oil ring and an oil scraper to prevent excessive oil consumption.

2. Discussion of the Related Art

Generally, a piston of an internal combustion engine performs 4-cycle reciprocation within a cylinder. In doing so, intake, compression, explosion and exhaust strokes are executed step by step to generate power. Hence, many efforts are made to improve a power output of an engine and to remove power-reducing factors.

The power-reducing factors include incomplete combustion, failure of an injection nozzle tip for injecting fuel, insufficient intake air, tightness failure of a piston ring, etc. In this case, the incomplete combustion occurs when fuel is burn together with and engine oil introduced into a combustion room of a cylinder.

In case that engine oil is introduced into a combustion room, carbon clod or soot sticks to a crown or circumference of a piston due to the incomplete combustion. Specifically, by the internal pressure generated from a crank side chamber in reciprocation of piston, engine oil or air flows backward to the combustion room. Or, fuel in introduced inside when a piston moves upward.

Such a problem is explained with reference to the attached drawings as follows.

FIG. 1A shows an intake stroke that air and fuel are sucked into a combustion room 10a as a piston 20 descends from a top dead center toward a bottom dead center as soon as an intake valve V1 is open. FIG. 1B shows a compression stroke that the air and fuel within the combustion room 10a are compressed into a state of high-temperature and high-pressure as the piston 20 ascends from the bottom dead end as soon as the intake valve V1 is closed. FIG. 1C shows an explosion stroke that the compressed high-temperature and high-pressure fuel supplied to the combustion room by the intake stroke is instantly exploded for combustion once the piston 20 arrives at the top dead center. FIG. 1D shows an exhaust stroke that combustion gas is exhausted from the combustion room 10a as the piston 20 moves toward the top dead center to open an exhaust valve V2.

Referring to FIGS. 1A to 1D, a plurality of ring grooves 22a and 23 are formed on a circumference of a piston 20 reciprocating within a cylinder 10. And, a compression ring 22 and an oil ring 24 are fitted in the ring grooves 22a and 23, respectively.

In reciprocation of the piston, the compression ring 22 compresses an inside of the cylinder to generate a plane pressure to provide a compression pressure within a combustion room 10a and the oil ring 24 is operative in scraping down engine oil.

In an intake stroke shown in FIG. 1A, the piston 20 is abruptly switched to a bottom dead center from a top dead center to descend while an intake valve V1 is open, whereby a vacuum state is provided within the combustion room 10a. Yet, a pressure within the piston 20 is abruptly raised. Hence, the reverse pressure air is moved along an arrow-A via an oil passage so that oil, as shown in FIG. 2C, attached to or remaining on the oil ring 24 and the ring groove 23 flows backward into the combustion room along an inner wall of a liner of the cylinder 10.

And, when the piston, as shown in FIG. 2C, moves downward, there exists no backside pressure of the piston ring. Hence, it is unable to maintain adherence to a lower end contact surface of the liner. So, an instant pressure within the piston enters the combustion room via a backside.

Thus, oil enters the combustion room together with air and becomes attached to a cylinder liner wall massively as well. When the piston 20 moves upward in the compression stroke (FIG. 1B), the compression ring 22 scrapes up the oil attached to the cylinder liner wall so that the scraped oil enters the combustion room along a path indicated by an arrow-B.

The engine oil having entered the combustion room has a high flash point to interrupt combustion in the explosion stroke (FIG. 1C), thereby resulting in incomplete combustion. Besides, black smoke is discharged in the exhaust stroke (FIG. 1D).

In operating the 4-cycle engine, the piston moves toward the top dead center in the exhaust stroke (FIG. 1D) to abruptly lower the internal pressure of the piston while the exhaust valve V2 is open. So, exhaust air of the combustion room 10a passes through a gap between the inner wall of the cylinder 10 and an outer wall of the piston 20 in a direction indicated by an arrow-D and a space between the compression ring 22 and the cylinder liner and then enters the cylinder 10 and the piston 20 via the ring groove 23 and the hole 26. Such a phenomenon occurs in the explosion exhaust (FIG. 1C) as the air moves along a path indicated by an arrow-C. This is because the oil is discharged or sucked via the space between the oil ring and the ring groove or via the oil window provided to a center of the oil ring.

The problem is explained in detail with reference to FIG. 2A and FIG. 2B as follows.

FIG. 2A shows species of oil rings provided to a piston. FIG. 2B shows a cross-section of a one-body type piston and an oil ring provided thereto. And, FIG. 2C is a magnified diagram of the oil ring in FIG. 2B.

A perforated hole 24c, as shown in FIG. 2A, is formed at a central portion of an oil ring 24 with a predetermined interval. And, a pair of upper and lower protrusions 24a and 24b are provided to an outer circumference of the oil ring 24. This is to continuously scrape down the oil attached to an inner wall of a cylinder liner in reciprocation of the piston. Namely, the oil attached to the inner wall of the cylinder liner is scraped down by the lower protrusion 24b and the rest oil is scraped down by the upper protrusion 24a. Hence, the oil can be dually scraped down.

The perforated hole 24c, as shown in FIG. 2A and FIG. 2B, guides the oil scraped down by the upper protrusion 24a of the oil ring to enter the perforated hole 24c so that the oil can flow into a piston inside 20b via the hole 26 communicating with the piston inside 20b.

However, the perforated hole 24c is formed at the center of the oil ring 24, whereby the oil flows backward by an internal pressure.

### SUMMARY OF THE INVENTION

Accordingly, the present invention is directed to a piston apparatus having an oil scraper ring that substantially obviates one or more problems due to limitations and disadvantages of the related art.

An object of the present invention is to provide a piston apparatus having an oil scraper ring, by which oil attached to an inner wall of a cylinder is effectively scraped off by adjusting lengths of upper and lower protrusions brought into contact with the inner wall of the cylinder, by which oil is prevented from flowing backward between the upper and lower protrusions by blocking a space between the upper and lower protrusions not to be perforated (by removing an oil window) when the oil flows backward by an internal pressure, in which a coil spring is deeply embedded in a ring to prevent a reverse pressure from rising within a piston through a backside of an oil ring, by which the reverse pressure is prevented from rising in a manner of raising thickness of the ring like a comp ring, in which the upper protrusion is thickened for anti-abrasion, in which the lower protrusion has a diameter smaller than that of the upper protrusion, in which several oil holes are perforated at a lower end of a scraper ring to provide both functions of the scraper ring and the oil ring, by which excessive consumption of lubricant is prevented, and by which smoke and output reduction due to incomplete combustion are prevented.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in an internal combustion engine piston including a plurality of compression rings and oil rings on a circumference, a piston apparatus according to the present invention includes an oil scraper ring provided to a ring groove formed below the compression ring, wherein upper and lower protrusions provided to an outer circumference of the oil scraper ring to be brought into contact with an inner circumference of a cylinder and wherein the upper and lower protrusions built in one body have no perforated hole in-between to provide a scraper function and an oil ring function simultaneously.

Preferably, each of the upper and lower protrusions has a taper shape, a groove is provided between the upper and lower protrusions to leave a space in-between, a contact length a of the upper protrusion brought into contact with the inner circumference of the cylinder is set to 1˜3 mmm, a contact length of the lower protrusion is set to 0.4˜1 mm, and a radius of the upper protrusion is greater than that of the lower protrusion by 0.5˜1 mm.

Preferably, a coil spring is provided to one side of the oil scraper ring to generate a tension and the coil spring is embedded in the oil scraper ring to leave a distance from a tip of the one side of the oil scraper ring.

Preferably, at least one oil hole is provided to the piston below the oil scraper ring to discharge an oil scraped by the upper and lower protrusions to an inside of the piston.

Preferably, the oil scraper ring provides a function of the oil ring.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1D are cross-sectional diagrams of an internal combustion engine according to a related art, in which piston cycles are shown;

FIG. 2A is a cross-sectional diagram of species of general piston rings;

FIG. 2B is a cross-sectional diagram of a one-body type piston provided with an oil ring;

FIG. 2C is a cross-sectional diagram along a bisecting line A-A in FIG. 2B;

FIG. 3 is a cross-sectional diagram of a piston apparatus having an oil scraper ring according to the present invention; and

FIG. 4 is a detailed cross-sectional diagram of a piston apparatus having an oil scraper ring according to the present invention.

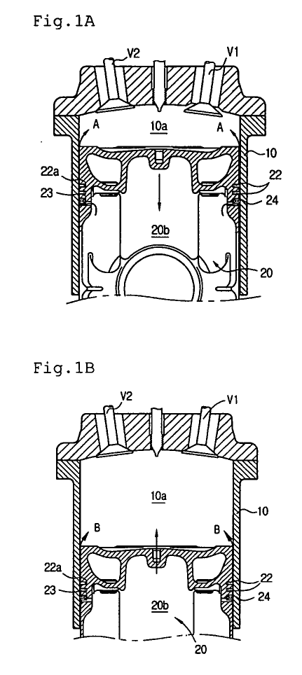

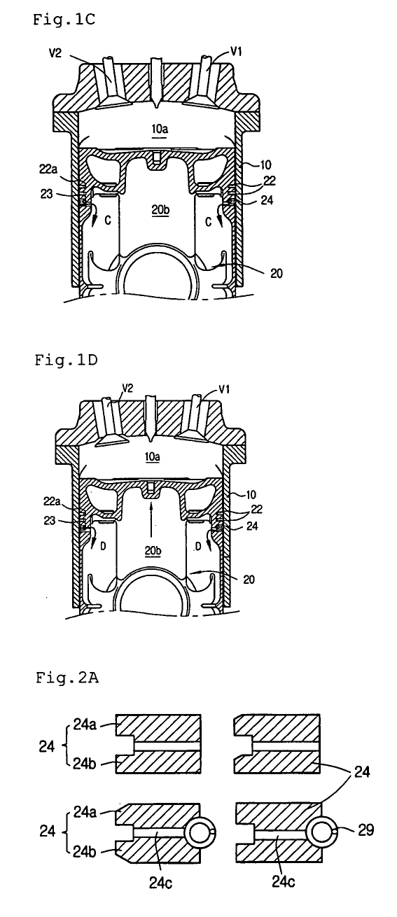

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

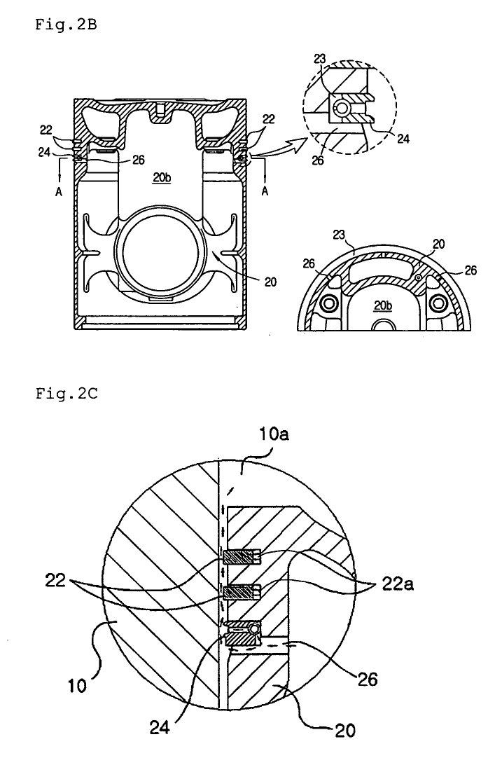

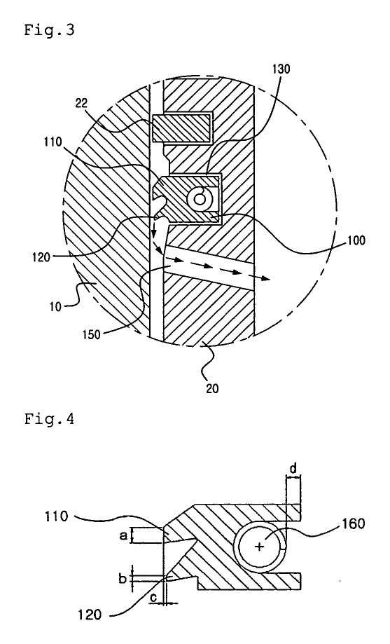

FIG. 3 is a cross-sectional diagram of a piston apparatus having an oil scraper ring according to the present invention and FIG. 4 is a detailed cross-sectional diagram of a piston apparatus having an oil scraper ring according to the present invention.

Referring to FIG. 3, in a piston, which has a plurality of compression rings and oil rings on its circumference, of an internal combustion engine, a compression ring 22 is provided to a circumference of a crown and an oil scraper ring 100 is provided to a ring groove 130 situated under the compression ring 22.

Referring to FIG. 3 and FIG. 4, upper and lower protrusions 110 and 120 are provided to an outer circumference of the oil scraper ring 100 to be brought into contact with an inner circumference of a cylinder 10. And, the upper and lower protrusions 110 and 120 have no perforated hole in-between to be built in one body.

Specifically, since there is no hole allowing oil to pass through between the upper and lower protrusions 110 and 120, the oil is prevented from flowing backward. And, a downwardly tilted groove is configured between the upper and lower protrusions 110 and 120.

Each of the upper and lower protrusions 110 and 120 has a taper shape. And, the groove is provided between the upper and lower protrusions 110 and 120 to leave a space in-between. A contact length a of the upper protrusion 110 brought into contact with the inner circumference of the cylinder 10 is set to 1˜3 mmm and a contact length b of the lower protrusion 120 is set to 0.4˜1 mm. Moreover, a plurality of oil holes 150 perforate a portion of the piston 20, to which the oil scraper ring 100 will be assembled, directly below the oil scraper ring 100 so that the oil can be recovered to a crank room to provide a function of an oil ring.

If the contact length a of the upper protrusion 110 brought into contact with the inner circumference of the cylinder 10 is smaller than 1 mm, the upper protrusion 110 of the oil scraper ring 100 is easily abraded to degrade endurance of product. If the contact length a is greater than 3 mm, the oil scraper ring 100 is too thick to maximize its function.

Hence, the contact length a of the upper protrusion 110 brought into contact with the inner circumference of the cylinder 10 is appropriately set to 1˜3 mm. Preferably, the contact length a is set to 2 mm. By the same principle, the other contact area b of the lower protrusion 120 of the oil scraper ring 100 brought into contact with the cylinder 10 is preferably set to 0.4˜1 mm.

Preferably, a difference c between a radius of the upper protrusion 110 and a radius of the lower protrusion 120 is set to 0.5˜1 mm. Hence, the radius of the upper protrusion 110 is set greater than that of the lower protrusion 120 by 0.5˜1 mm.

Moreover, since the oil scraper ring 100 is provided with both of the oil scraper function and the oil recovery function without a window, the present invention need not install a separate oil ring.

In the above-configured piston apparatus having the oil scraper ring according to the present invention, when the piston 20 brought into contact with the inner wall of the cylinder 10 is moving down, the lower protrusion 120 provided to the circumference of the piston 20 scrapes of the oil attached to the inner wall of the cylinder 10. And, the scraped oil is discharged via the oil holes 150 situated below the oil scraper ring. Hence, the internal pressure of the piston does not flow backward along the hole of the oil ring groove.

And, the upper protrusion 110 provided above the lower protrusion 120 doubly scrapes down the oil remaining on the inner wall of the cylinder 10 after the lower protrusion 120 has scraped off the oil.

In doing so, since there is no hole for the oil to pass through between the upper and lower protrusions 110 and 120 of the oil scraper ring 100, the oil is prevented from flowing backward. And, compared to the related art oil ring, the oil scraper ring 100 can perfectly scrape down the oil attached to the inner wall of the cylinder 10 to discharge the scraped oil via the oil holes 150.

Accordingly, in the above-configured piston apparatus having the oil scraper ring according to the present invention, the upper protrusion widens the contact area with the cylinder but the lower protrusion narrows the contact area with the cylinder. If the lower protrusion primarily scrapes down the oil, the upper protrusion secondarily scrapes off the remaining oil from the inner wall of the cylinder. The oil ring is generally provided with an oil window via which the internal pressure of the piston or cylinder flows backward. Yet, the present invention removes the oil window to prevent the oil from flowing backward between the upper and lower protrusions and to prevent the engine oil from entering the combustion room while the piston is moving downward. Therefore, the present invention prevents smoke due to the incomplete combustion and needs no separate oil ring.

It will be apparent to those skilled in the art that various modifications and variations can be made in the present invention. Thus, it is intended that the present invention covers the modifications and variations of this invention provided they come within the scope of the appended claims and their equivalents.

1. In an internal combustion engine piston including a plurality of compression rings and oil rings on a circumference, a piston apparatus including an oil scraper ring provided to a ring groove formed below the compression ring, wherein upper and lower protrusions provided to an outer circumference of the oil scraper ring to be brought into contact with an inner circumference of a cylinder and wherein the upper and lower protrusions built in one body have no perforated hole in-between to provide a scraper function and an oil ring function simultaneously.

2. The piston apparatus of claim 1, wherein each of the upper and lower protrusions has a taper shape, wherein a groove is provided between the upper and lower protrusions to leave a space in-between, wherein a contact length a of the upper protrusion brought into contact with the inner circumference of the cylinder is set to 1˜3 mm, wherein a contact length b of the lower protrusion is set to 0.4˜1 mm, and wherein a radius of the upper protrusion is greater than that of the lower protrusion by 0.5˜1 mm.

3. The piston apparatus of claim 1, wherein a coil spring is provided to one side of the oil scraper ring to generate a tension and wherein the coil spring is embedded in the oil scraper ring to leave a distance d from a tip of the one side of the oil scraper ring.

4. The piston apparatus of claim 1, wherein at least one oil hole is provided to the piston below the oil scraper ring to discharge an oil scraped by the upper and lower protrusions to an inside of the piston.

5. The piston apparatus of claim 1, wherein the oil scraper ring provides a function of the oil ring.
